(19) United States
(12) Patent Application Publication
(10) Pub. No.: US 2026/0265421 A1
(43) Pub. Date: Sep. 10, 2026

(54) POLYPROPYLENE RESIN COMPOSITON

(71) Applicant: Basell Poliolefine Italia S.r.l., Milano (IT)

(72) Inventors: Antonio Riemma, Ferrara (IT); Andrea Felisati, Ferrara (IT); Marco Bocchino, Ferrara (IT); Claudio Cavalieri, Ferrara (IT); Giampaolo Pellegatti, Ferrara (IT)

(73) Assignee: Basell Poliolefine Italia S.r.l., Milano (IT)

(21) Appl. No.: 19/165,854

(22) PCT Filed: Oct. 5, 2023
(86) PCT No.: PCT/EP2023/077550

§ 371 Date: Sep. 16, 2025

(30) Foreign Application Priority Data
Mar. 21, 2023 (EP) 23163207.6

(51) Int. Cl. C08F 10/06; C08J 5/18

(52) U.S. Cl. CPC C08F 10/06; C08J 5/18

(57) ABSTRACT

A polypropylene resin composition comprising: A) from 10 wt % to 70 wt % of a polypropylene homopolymer composition comprising: T1) from 30 wt % to 70 wt % of a first propylene homopolymer optionally containing up to 1.0 wt % of ethylene derived units having: —the intrinsic viscosity (IV) measured in tetrahydronaphthalene at 135° C. ranging from 8.0 to 13.0 dl/g; T2) from 30 wt % to 70 wt % of a second propylene homopolymer optionally containing up to 1.0 wt % of ethylene derived units having: —the intrinsic viscosity (IV) measured in tetrahydronaphthalene at 135° C. ranging from 2.0 to 4.5 dl/g; B) from 30 wt % to 90 wt % of an organic material selected from: organic acid esters; adipic acid esters, glyceric acid esters; phosphoric acid esters; paraffin; wax; and mineral oil; wherein the sum of the amounts of component A) and component B) in wt % is equal to 100 wt %.

### FIELD OF THE INVENTION

In general, the present disclosure relates to the field of chemistry. More specifically, the present disclosure relates to polymer chemistry. In particular, the present disclosure relates to polypropylene resin composition made from or containing an ultra-high-molecular-weight propylene homopolymer composition containing at least two homopolymer fractions, having different intrinsic viscosity, and a microporous membrane made therefrom.

### BACKGROUND OF THE INVENTION

Microporous membranes, made of polymeric materials, are used in various applications. In some instances, the applications include filter membranes and separation membranes for medical and industrial use, and separators, such as battery separators and condenser separators. In some instances, the battery separators are used in secondary batteries, which are used as power supplies for mobile phones, mobile personal computers, and automobiles.

### SUMMARY OF THE INVENTION

In a general embodiment, the present disclosure provides a polypropylene resin composition made from or containing:
A) from 10 wt % to 70 wt % of a polypropylene homopolymer composition made from or containing:
   T1) from 30 wt % to 70 wt % of a first propylene homopolymer, optionally containing up to 1.0 wt % of ethylene derived units, having:
      an intrinsic viscosity (IV), measured in tetrahydronaphthalene at 135° C., ranging from 8.0 to 13.0 dl/g; and
   T2) from 30 wt % to 70 wt % of a second propylene homopolymer, optionally containing up to 1.0 wt % of ethylene derived units, having:
      an intrinsic viscosity (IV), measured in tetrahydronaphthalene at 135° C., ranging from 2.0 to 5.5 dl/g;
         the sum of the amounts of T1)+T2) being 100 wt %;
         wherein the propylene homopolymer composition has the following features:
      two melting points present in the DSC thermogram, measured according to ISO 11357-3, with heating and cooling rate of 20° C./min;
      the higher melting point, measured according to ISO 11357-3, with heating and cooling rate of 20° C./min, ranging from 155° C. to 170° C.;
      the isotactic pentads mmmm %, measured with 13C-NMR, ranging from 94.5 mol % to 89.0 mol %;
         a melt strength, measured according to ISO 16790-2005, at 250° C. and applying an acceleration equal to 6 mm/s², higher than 0.070 N;
      a fraction soluble in xylene at 25° C., measured according to ISO 16 152-2005, between 6.0 wt % and 2.0 wt %; and
      an intrinsic viscosity (IV), measured in tetrahydronaphthalene at 135° C., ranging from 10.0 to 4.5 dl/g; and
B) from 30 wt % to 90 wt % of an organic material selected from the group consisting of organic acid esters, adipic acid esters, glyceric acid esters, phosphoric acid esters, paraffin; wax, and mineral oil, wherein the sum of the amounts of component A) and component B) in wt % is equal to 100 wt %.

### DETAILED DESCRIPTION OF THE INVENTION

In some embodiments, the present disclosure provides a polypropylene resin composition made from or containing:
A) from 10 wt % to 70 wt %, alternatively from 20 wt % to 60 wt %; alternatively from 30 wt % to 57 wt %, of a polypropylene homopolymer composition comprising:
   T1) from 30 wt % to 70 wt %; alternatively from 40 wt % to 60 wt %; alternatively from 45 wt % to 55 wt %; of a first propylene homopolymer, optionally containing up to 1.0 wt % of ethylene derived units, having:
      an intrinsic viscosity (IV), measured in tetrahydronaphthalene at 135° C., ranging from 8.0 dl/g to 13.0 dl/g; alternatively from 8.5 dl/g to 12.0 dl/g; alternatively from 8.8 dl/g to 11.5 dl/g; and
   T2) from 30 wt % to 70 wt % alternatively from 40 wt % to 60 wt %; alternatively from 45 wt % to 55 wt %; of a second propylene homopolymer, optionally containing up to 1.0 wt % of ethylene derived units, having:
      an intrinsic viscosity (IV), measured in tetrahydronaphthalene at 135° C., ranging from 2.0 to 5.5 dl/g; alternatively from 2.2 to 5.0 dl/g; alternatively from 2.5 to 4.7 dl/g;
         the sum of the amounts of T1)+T2) being 100 wt %;
wherein the propylene homopolymer composition has the following features:
   two melting points present in the DSC thermogram, measured according to ISO 11357-3, 20° C./min;
   the higher melting point, measured according to ISO 11357-3, with heating and cooling rate of 20° C./min, ranging from 155° C. to 170° C.; alternatively from 157° C. to 168° C.;
   the isotactic pentads mmmm %, measured with C¹³NMR, ranging from 94.5 mol % to 89.0 mol %; alternatively from 93.2 mol % to 90.5 mol %; alternatively from 93.0 mol % to 91.0 mol %;
   a fraction soluble in xylene at 25° C., measured according to ISO 16 152-2005, between 5.0 wt % and 2.0 wt %; alternatively between 5.0 wt % and 2.5 wt %; alternatively between 4.5 wt % and 2.2 wt %; alternatively between 3.5 wt % and 2.4 wt %;
   a melt strength, measured according to ISO 16790-2005 at 250° C. and applying an acceleration equal to 6 mm/s², higher than 0.070 N; alternatively higher than 0.080 N; alternatively higher than 0.082 N; and
   an intrinsic viscosity (IV), measured in tetrahydronaphthalene at 135° C., ranging from 10.0 to 4.5 dl/g; alternatively from 9.2 to 5.2 dl/g; alternatively from 8.5 to 5.5 dl/g; and
B) from 30 wt % to 90 wt %; alternatively from 40 wt % to 80 wt %; alternatively from 43 wt % to 70 wt %; of an organic material selected from the group consisting of organic acid esters; adipic acid esters; glyceric acid esters; phosphoric acid esters; paraffin; wax; and mineral oil;
   wherein the sum of the amounts of component A) and component B) in wt % is equal to 100 wt %. In some embodiments, the propylene homopolymer composition has the lower melting point ranging from 135° C. to 150° C. In some embodiments, the organic acid esters are selected from the group consisting of dioctyl phthalate, diheptyl phthalate, and dibutyl phthalate. In some embodiments, the phosphoric acid ester is trioctyl phosphate. In some embodiments, the paraffin is selected from the group consisting of liquid paraffin and solid paraffin.

In some embodiments, the propylene homopolymer component A) is not nucleated.

In some embodiments, the melt strength of the propylene homopolymer component A) is lower than 0.30 N.

In some embodiments, the propylene homopolymer component A) shows a polydispersity index, PI, measured according to ISO 6721-10, between 4.5 and 7.5; alternatively between 5.0 and 7.2; alternatively from 5.5 to 7.0.

In some embodiments, the propylene homopolymer component A) shows a tensile modulus ranging from 2100 MPa to 1100 MPa; alternatively from 1800 MPa, to 1200 MPa.

In some embodiments, the propylene homopolymer component A) shows a Charpy impact test at 23° C. ranging from 4.0 kJ/m² to 11.0 kJ/m²; alternatively from 4.5 kJ/m² to 7.5 kJ/m².

In some embodiments, the ratio of component T1) and component T2) modifies the intrinsic viscosity and the melt strength of the composition.

In some embodiments, the propylene homopolymer component A) is prepared by a process including the step of polymerizing propylene optionally with ethylene, in the presence of Ziegler-Natta catalysts in two reactors connected in series. The Ziegler-Natta catalysts are made from or containing a solid catalyst component made from or containing a titanium compound having at least one titanium-halogen bond, and an electron-donor compound, both supported on a magnesium halide in active form. The Ziegler-Natta catalysts are used with an organoaluminum compound as a cocatalyst. In some embodiments, the organoaluminum compound is an aluminum alkyl compound. An external donor is optionally added.

In some embodiments, the catalysts are as described in U.S. Pat. No. 4,399,054 and European Patent No. 45977. In some embodiments, the catalysts are as described in U.S. Pat. No. 4,472,524.

In some embodiments, the solid catalyst components are made from or containing electron-donors (internal donors) selected from the group consisting of ethers, ketones, lactones, compounds containing N, P, S, or a combination of these atoms, and esters of mono- and dicarboxylic acids.

In some embodiments, the electron-donor compounds are esters of succinic acid (succinates). In some embodiments, the succinate has formula (I) below

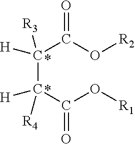

wherein the radicals R₁ and R₂, equal to or different from, each other are a C₁-C₂₀ linear or branched alkyl, alkenyl, cycloalkyl, aryl, arylalkyl or alkylaryl group, optionally containing heteroatoms; and the radicals R₃ and R₄, equal to or different from, each other, are C₁-C₂₀ alkyl, C₃-C₂₀ cycloalkyl, C₅-C₂₀ aryl, arylalkyl or alkylaryl group with the proviso that at least one of R₃ and R₄ is a branched alkyl. In some embodiments, the compounds are, with respect to the two asymmetric carbon atoms identified in the structure of formula (I), stereoisomers of the type (S,R) or (R,S)

In some embodiments, R₁ and R₂ are selected from the group consisting of C₁-C₈ alkyl, cycloalkyl, aryl, arylalkyl and alkylaryl groups. In some embodiments, R₁ and R₂ are selected from primary alkyls, alternatively branched primary alkyls. In some embodiments, R₁ and R₂ groups are selected from the group consisting of methyl, ethyl, n-propyl, n-butyl, isobutyl, neopentyl, and 2-ethylhexyl. In some embodiments, R₁ and R₂ groups are selected from the group consisting of ethyl, isobutyl, and neopentyl.

In some embodiments, the R₃ radical, the R₄ radical, or both are secondary alkyls or cycloalkyls. In some embodiments, the secondary alkyls are selected from the group consisting of isopropyl, sec-butyl, 2-pentyl, and 3-pentyl. In some embodiments, the cycloalkyls are selected from the group consisting of cyclohexyl, cyclopentyl, and cyclohexylmethyl.

In some embodiments, the compounds are the (S,R) (S,R) forms pure or in mixture, optionally in racemic form, of diethyl 2,3-bis(trimethylsilyl) succinate, diethyl 2,3-bis(2-ethylbutyl) succinate, diethyl 2,3-dibenzylsuccinate, diethyl 2,3-diisopropylsuccinate, diisobutyl 2,3-diisopropylsuccinate, diethyl 2,3-bis(cyclohexylmethyl) succinate, diethyl 2,3-diisobutylsuccinate, diethyl 2,3-dineopentylsuccinate, diethyl 2,3-dicyclopentylsuccinate, and diethyl 2,3-dicyclohexylsuccinate.

In some embodiments, the electron-donor compounds are esters of phthalic acid and 1,3-diethers of formula:

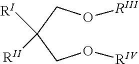

wherein R^{I} and R^{II} are the same or different and are C₁-C₁₈ alkyl, C₃-C₁₈ cycloalkyl or C₇-C₁₈ aryl radicals; R^{III} and R^{IV} are the same or different and are C₁-C₄ alkyl radicals; or are the 1,3-diethers wherein the carbon atom in position 2 belongs to a cyclic or polycyclic structure made up of 5, 6, or 7 carbon atoms, or of 5-n or 6-n′ carbon atoms, and respectively n nitrogen atoms and n′ heteroatoms selected from the group consisting of N, O, S and Si, where n is 1 or 2 and n′ is 1, 2, or 3, the structure containing two or three unsaturations (cyclopolyenic structure), and optionally being condensed with other cyclic structures, or substituted with one or more substituents selected from the group consisting of linear or branched alkyl radicals; cycloalkyl, aryl, aralkyl, alkaryl radicals and halogens, or being condensed with other cyclic structures and substituted with one or more of the above-mentioned substituents; one or more of the above-mentioned alkyl, cycloalkyl, aryl, aralkyl, or alkaryl radicals and the condensed cyclic structures optionally containing one or more heteroatom(s) as substitutes for carbon or hydrogen atoms, or both. In some embodiments, the substituents are bonded to the condensed cyclic structures.

In some embodiments, the ethers are selected from the ethers described in European Patent Application Nos. 361493 and 728769.

In some embodiments, the diethers are selected from the group consisting of 2-methyl-2-isopropyl-1,3-dimethoxypropane, 2,2-diisobutyl-1,3-dimethoxypropane, 2-isopropyl-2-cyclopentyl-1,3-dimethoxypropane, 2-isopropyl-2-isoamyl-1,3-dimethoxypropane, and 9,9-bis(methoxymethyl) fluorene.

In some embodiments, the electron-donor compounds are phthalic acid esters. In some embodiments, the phthalic acid esters are selected from the group consisting of diisobutyl phthalate, dioctyl phthalate, diphenyl phthalate, and benzylbutyl phthalate.

In some embodiments, a MgCl₂·nROH adduct is reacted with an excess of TiCl₄ containing the electron-donor compound. In some embodiments, the adduct is in the form of spheroidal particles. In some embodiments, n is from 1 to 3. In some embodiments, ROH is selected from the group consisting of ethanol, butanol, and isobutanol. In some embodiments, the reaction temperature is from 80 to 120° C. The solid is then isolated and reacted once more with TiCl₄, in the presence or absence of the electron-donor compound, after which the reaction product is separated and washed with aliquots of a hydrocarbon until the chlorine ions have disappeared.

In some embodiments and in the solid catalyst component, the titanium compound, expressed as Ti, is present in an amount from 0.5 to 10% by weight. In some embodiments, the quantity of electron-donor compound, which remains fixed on the solid catalyst component, is 5 to 20% by moles with respect to the magnesium dihalide.

In some embodiments, the titanium compounds, used for the preparation of the solid catalyst component, are selected from the group consisting of halides of titanium and halogen alcoholates of titanium. In some embodiments, the titanium compound is titanium tetrachloride.

In some embodiments, the reactions form a magnesium halide in active form. In some embodiments, magnesium halide in active form results from reactions starting with magnesium compounds other than halides, such as magnesium carboxylates.

In some embodiments, the Al-alkyl compounds used as co-catalysts are made from or containing Al-trialkyls or linear or cyclic Al-alkyl compounds. In some embodiments, the Al-trialkyls are selected from the group consisting of Al-triethyl, Al-triisobutyl, and Al-tri-n-butyl. In some embodiments, the linear or cyclic Al-alkyl compounds contain two or more Al atoms bonded to each other by O or N atoms, or SO₄ or SO₃ groups.

In some embodiments, the Al-alkyl compound is used in a quantity such that the Al/Ti ratio is from 1 to 1000.

In some embodiments, the electron-donor compounds used as external donors are selected from the group consisting of aromatic acid esters and silicon compounds. In some embodiments, the aromatic acid esters are alkyl benzoates. In some embodiments, the silicon compounds contain at least one Si—OR bond, where R is a hydrocarbon radical.

In some embodiments, the silicon compounds are selected from the group consisting of (tert-butyl)₂Si(OCH₃)₂, (cyclohexyl)(methyl)Si(OCH₃)₂, (cyclopentyl)₂Si(OCH₃)₂, (phenyl)₂Si(OCH₃)₂ and (1,1,2-trimethylpropyl)Si(OCH₃)₃.

In some embodiments, the internal donor is a 1.3-diether and the external donors are omitted.

In some embodiments, the component A) is prepared by using catalysts containing a phthalate, as internal donor, and (cyclopentyl)₂Si(OCH₃)₂, as outside donor. In some embodiments, the component A) is prepared by using catalysts containing 1,3-diethers as internal donors.

In some embodiments, the polymerization is carried out at temperatures of from 20 to 120° C., alternatively of from 40 to 80° C. In some embodiments, the polymerization is carried out in gas-phase with the operating pressure between 0.5 and 5 MPa, alternatively between 1 and 4 MPa. In some embodiments, the polymerization is carried out in bulk polymerization with the operating pressure between 1 and 8 MPa, alternatively between 1.5 and 5 MPa. In some embodiments, hydrogen is used as a molecular weight regulator. In some embodiments, the polymerization is carried out in gas phase, in slurry, or in solution. In some embodiments, the polymerization is carried out in one or more reactors. In some embodiments, the polymerization is carried out in two slurry reactors operating in series, by varying the hydrogen concentration in the two reactors.

In some embodiments, the organic material component B) is selected from the group consisting of liquid paraffin, solid paraffin, wax, and mineral oil. In some embodiments, the organic material component B) is a mineral oil; alternatively white mineral oil (CAS 8042-47-5).

In some embodiments, the composition is obtained with a process including the step of mixing component A) and component B), thereby performing a granulation in a mixer.

In some embodiments, the present disclosure provides a microporous membrane made from or containing the polypropylene resin composition.

In some embodiments, the present disclosure provides a process for obtaining the microporous membrane including the steps of (i) mixing organic material component B) with component A), thereby forming a mixture; (ii) heating and melting the mixture, thereby forming a melt; (iii) extruding the melt into a sheet; (iv) orientating the sheet biaxially, either simultaneously or sequentially, and (v) extracting the liquid with a volatile solvent. In some embodiments, the solvent is dichloromethane.

In some embodiments, the membrane is subjected to a heat-setting process, thereby enhancing the dimensional stability and preventing shrinkage or wrinkle formation upon heating.

The microporous membrane obtained with the composition of the present disclosure shows a good Gurley permeability, measured according to ISO 5636.

In some embodiments, the porosity ranges from 30.0% to 60.0%, alternatively from 33.0% to 51.0%; alternatively from 34.0% to 45.0%.

In some embodiments, the puncture resistance of the microporous membrane, normalized for 20 μm, ranges from 700 g/20 μm to 1200 g/20 μm; alternatively from 750 g/20 μm to 150 g/20 μm; alternatively from 800 g/20 μm to 998 g/20 μm.

In some embodiments, the microporous membrane has a Gurley permeability, normalized to 20 μm thickness measured according to ISO 5636, lower than 1200 s/100 ml 720 μm, alternatively lower than 1100 s/100 m/20 μm, alternatively lower than 850 s/100 m/20 μm.

The following examples are given for illustration, without limiting the scope of the disclosure.

### EXAMPLES

### Characterizations

### Xylene-Insoluble and Soluble Fraction at 25° C.

Xylene Solubles fraction has been measured according to ISO 16 152-2005; with solution volume of 250 ml, precipitation at 25° C. for 20 minutes, including 10 minutes with the solution in agitation (magnetic stirrer), and drying at 70°.

### Melt Flow Rate (MFR)

Measured according to ISO 1133 at 230° C. with a load of 21.6 kg, unless otherwise specified.

### Polydispersity (PI)

Molten homopolymer was submitted to a dynamic test in rate sweep with a parallel plate rheometer, at temperature of 200° C., according to the ISO 6721-10. G′ (storage modulus) and G″ (loss modulus) were measured as function of frequency. From the rate sweep data, PI is defined by PI=105/Gc, wherein Gc is the crossover modulus as value of modulus at G′=G″.

### Melting Temperature Via Differential Scanning Calorimetry (DSC)

The melting points of the polymers (Tm) were measured by differential scanning calorimetry (DSC) on a Perkin Elmer DSC-1 calorimeter, calibrated against indium melting points, and according to ISO 11357-1, 2009 and 11357-3, 2011, at 20° C./min. The weight of the samples in the DSC crucibles was 6.0±0.5 mg.

To obtain the melting point, the samples were sealed into aluminum pans and heated to 200° C. at 20° C./minute. The samples were maintained at 200° C. for 2 minutes, thereby allowing for melting of the crystallites, and then cooled to 5° C. at 20° C./minute. After standing 2 minutes at 5° C., samples were heated for the second run time to 200° C. at 20° C./min. In this second heating run, the peak temperature (Tp,m) was taken as the melting temperature.

### ¹³C NMR of Homopolymer and Propylene/Ethylene Copolymers

¹³C NMR spectra were acquired on a Bruker AV-600 spectrometer equipped with cryoprobe, operating at 160.91 MHz in the Fourier transform mode at 120° C.

The peak of the S_{ββ} carbon (nomenclature according to “Monomer Sequence Distribution in Ethylene-Propylene Rubber Measured by ¹³C NMR. 3. Use of Reaction Probability Mode” C. J. Carman, R. A. Harrington and C. E. Wilkes, Macromolecules, 1977, 10, 536) was used as internal standard at 29.9 ppm. The samples were dissolved in 1,1,2,2-tetrachloroethane-d2 at 120° C. with an 8% wt/v concentration. Each spectrum was acquired with a 90° pulse, 15 seconds of delay between pulses and CPD, thereby removing ¹H-¹³C coupling. 512 transients were stored in 32K data points using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with 8-titanium trichloride-diethylaluminum chloride” M. Kakugo, Y. Naito, K. Mizunuma and T. Miyatake, Macromolecules, 1982, 15, 1150) using the following equations:

$$\begin{matrix}PPP = 100 {T}_{ββ} / S & PPE = 100 {T}_{βδ} / S & EPE = 100 {T}_{δδ} / S \\ PEP = 100 {S}_{ββ} / S & PEE = 100 {S}_{βδ} / S & EEE = 100 ( 0.25 {S}_{γδ} + 0.5 {S}_{δδ} ) / S\end{matrix} \\ S = {T}_{ββ} + {T}_{βδ} + {T}_{δδ} + {S}_{ββ} + {S}_{βδ} + 0.25 {S}_{γ δ} + 0.5 {S}_{δ δ}$$

The molar percentage of ethylene content was evaluated using the following equation:

$$E \% mol = 100 * [ PEP + PEE + EEE ]$$

The weight percentage of ethylene content was evaluated using the following equation:

$$E \% wt . = \frac{100 * E \% mol * M {W}_{E}}{E \% mol * M {W}_{E} + P \% mol * M {W}_{P}}$$

where P % mol is the molar percentage of propylene content, while MW_{E} and MW_{P} are the molecular weights of ethylene and propylene, respectively.

The product of reactivity ratio r₁r₂ was calculated according to Carman (C. J. Carman, R. A. Harrington and C. E. Wilkes, Macromolecules, 1977; 10, 536) as:

$${r}_{1} {r}_{2} = 1 + ( \frac{EEE + PEE}{PEP} + 1 ) - ( \frac{P}{E} + 1 ) {( \frac{EEE + PEE}{PEP} + 1 )}^{0.5}$$

The tacticity of propylene sequences was calculated as mm content from the ratio of the PPP mmT_{ββ} (28.90-29.65 ppm) and the whole T_{ββ} (29.80-28.37 ppm).

### Intrinsic Viscosity

The sample was dissolved in tetrahydronaphthalene at 135° C. and then poured into the capillary viscometer. The viscometer tube (Ubbelohde type) was surrounded by a cylindrical glass jacket, which permitted temperature control with a circulating thermostatic liquid. The downward passage of the meniscus was timed by a photoelectric device. The passage of the meniscus in front of the upper lamp started. The counter had a quartz crystal oscillator. The counter stopped as the meniscus passed the lower lamp. The efflux time was registered and converted into a value of intrinsic viscosity through Huggins' equation, using the flow time of the solvent at the same experimental conditions (same viscometer and same temperature). A single polymer solution was used to determine [η].

### Melt Strength

The melt strength was measured according to ISO 16790-2005 by Haul-off Melt Strength Meter produced by Geottfert Werkstoff Pruefmaschinen, Germany. The system measured the extensional properties of polymer melts by drawing a vertical melt strand at a constant pull-off speed or with a linear or exponentially accelerating velocity. The HAUL-OFF system measured the force for elongating the strand, and calculated elongation stress, draw ratio and apparent elongation rate and viscosity. The sample was melted and plasticized through a capillary rheometer. The polymer melt was extruded from a hole die with a 1 mm of diameter, 30 mm of length and 180° inlet angle. The test was performed at 250° C. The distance from the capillary outlet to the center of the transducer pulley was 150 mm. The monofilament was stretched at each temperature test, applying an acceleration equal to 6 mm/s², and, passing through an angular transducer, the sample's tension was measured. The draw ratio (dimensionless value) and force (cN) values were recorded as the final result in addition to the entire curve. The value of the melt strength is considered the maximum force value of the curve.

### Charpy Impact Test

Charpy impact test is measured according to ISO 179-1eA, e ISO 1873-2, on compression sample

### Tensile Modulus

Tensile Modulus is measured according to ISO 527-2, and ISO 1873-2 on compression sample

### Examples 1—Preparation of Homopolymer

### Procedure for the Preparation of the Solid Catalyst Component

The solid catalyst was prepared according to the Example 10 of Patent Cooperation Treaty Publication No. WO 00/63261. Triethylaluminum (TEAL) was used as co-catalyst and dicyclopentyldimethoxysilane as external donor, with the weight ratios indicated in Table 1.

### Polymerization

The polymerization run was carried out in continuous mode in a series of two reactors, equipped with devices to transfer the product from a first reactor to a second reactor immediately next to the first reactor. The two reactors were liquid phase loop reactors. Propylene was the solvent. Hydrogen was used as a molecular weight regulator.

The gas phase (propylene, ethylene and hydrogen) was continuously analyzed via gas-chromatography.

At the end of the run, the powder was discharged and dried under a nitrogen flow.

The main polymerization conditions and the properties of the polymer are reported in Tables 1 and 2.

TABLE 1
Polymerization conditions

| | Ex 1 |
|---|---|
| TEAL/catalyst (wt ratio) | 5.4 |
| TEAL/ext donor (wt ratio) | 3 |
| first loop | |
| Temperature ° C. | 65 |
| Pressure barg | 40 |
| H₂ ppmol | <10 ppmol |
| split wt % | 50 |
| second loop | |
| Temperature ° C. | 75 |
| Pressure barg | 40 |
| H₂ ppmol | 450 ppmol |
| split wt % | 50 |

The features of the polymers of example 1 are reported in Table 2.

TABLE 2

| Example | | 1 |
|---|---|---|
| component T1) | wt % | 50 |
| IV | dl/g | 9.3 |
| component T2) | wt % | 50 |
| IV | dl/g | 3.7 |
| total composition | | |
| MFR | g/10 min | 3.39 |
| IV | dl/g | 6.5 |
| XS | wt % | 2.7 |
| mmmm | mol % | 92.4 |
| Polydispersity , PI | | 6.6 |
| tensile modulus | MPa | 1480 |
| Charpy impact test at 23° C. | kJ/m² | 5.7 |
| melt strength | N | 0.088 |
| Tm 1 | ° C. | |
| Tm 2 | ° C. | |

IV of component T2 was calculated with the relation IVtot=IV_{T1X1}+IV_{T2X2}, wherein X1+X2=1 being the relative amount of T1 and T2.

The polymer of example 1 (component A) was mixed with white mineral oil (CAS 8042-47-5) as component B. The white mineral oil was commercially available from Kukdong.

The resulting composition was used to prepare a sheet. The resulting sheet was stretched in biaxial direction 7×7 times. The sheet was treated with dichloromethane, thereby removing component B) and forming a microporous membrane. The features of the microporous membrane are reported on Table 3.

TABLE 3

| | Poly- | | | | Gurley* s/ | | Puncture* |
|---|---|---|---|---|---|---|---|
| | mer | Oil | Stretching | Thickness | 100 ml/ | Porosity | Resistance |
| EX | % | % | T ° C. | μm | 20 μm | % | g/20 μm |
| a | 55 | 45 | 153 | 22 | 1063 | 32.3 | 957 |
| c | 40 | 60 | 153 | 10 | 799 | 43.1 | nm |

*Normalized for 20 μm sheet
Nm not measured
Gurley permeability was measured according to ISO 5636 and normalized for 20 μm sheet.

### Abstract

A polypropylene resin composition made from or containing:
A) from 10 wt % to 70 wt % of a polypropylene homopolymer composition made from or containing:
   T1) from 30 wt % to 70 wt % of a first propylene homopolymer having:
      an intrinsic viscosity (IV), measured in tetrahydronaphthalene at 135° C., ranging from 8.0 to 13.0 dl/g; and
   T2) from 30 wt % to 70 wt % of a second propylene homopolymer having:
      an intrinsic viscosity (IV), measured in tetrahydronaphthalene at 135° C., ranging from 2.0 to 4.5 dl/g; and
B) from 30 wt % to 90 wt % of an organic material selected from the group consisting of organic acid esters, adipic acid esters, glyceric acid esters, phosphoric acid esters, paraffin, wax, and mineral oil; wherein the sum of the amounts of component A) and component B) in wt % is equal to 100 wt %.

What is claimed is:

1. A polypropylene resin composition comprising:
A) from 10 wt % to 70 wt % of a polypropylene homopolymer composition comprising:
T1) from 30 wt % to 70 wt % of a first propylene homopolymer, optionally containing up to 1.0 wt % of ethylene derived units, having:
an intrinsic viscosity (IV), measured in tetrahydronaphthalene at 135° C., ranging from −8.0 to 13.0 dl/g; and
T2) from 30 wt % to 70 wt % of a second propylene homopolymer, optionally containing up to 1.0 wt % of ethylene derived units, having:
an intrinsic viscosity (IV), measured in tetrahydronaphthalene at 135° C., ranging from −2.0 to 4.5 dl/g;
the sum of the amounts of T1)+T2) being 100 wt %;
wherein the propylene homopolymer composition has the following features:
two melting points present in the DSC thermogram, measured according to ISO-11357-3, with heating and cooling rate of 20° C./min;
the higher melting point, measured according to ISO-11357-3. 20° C./min, ranging from 155° C. to 170° C.;
the isotactic pentads mmmm %, measured with C¹³NMR, ranging from 94.5 mol % to 89.0 mol %;
a melt strength, measured according to ISO 16790-2005, at 250° C. and applying an acceleration equal to 6 mm/s², higher than 0.070 N;
a fraction soluble in xylene at 25° C. between 6.0 wt % and 2.0 wt %; and
an intrinsic viscosity (IV), measured in tetrahydronaphthalene at 135° C., ranging from 10.0 to 4.5 dl/g; and
B) from 30 wt % to 90 wt % of an organic material selected from the group consisting of organic acid esters, adipic acid esters, glyceric acid esters, phosphoric acid esters,
paraffin, wax, and mineral oil;
wherein the sum of the amounts of component A) and component B) in wt % is equal to 100 wt %.

2. The polypropylene resin composition according to claim 1, wherein component A) has two melting points present in the DSC thermogram, measured according to ISO-11357-3, with heating and cooling rate of 20° C./min; and the lower melting point ranging from 135° C. to 150° C.

3. The polypropylene resin composition according to claim 1, wherein component A) has the higher melting point, measured according to ISO-11357-3, with heating and cooling rate of −20° C./min, ranging from 157° C. to 168° C.

4. The polypropylene resin composition according to claim 1, wherein component A) has the fraction soluble in xylene at 25° C. between 5.0 wt % and 2.5 wt %.

5. The polypropylene resin composition according to claim 1, wherein component T1) ranges from 40 wt % to 60 wt % and component T2) ranges from 40 wt % to 60 wt %.

6. The polypropylene resin composition according to claim 1, wherein component A) has the isotactic pentads mmmm %, measured with 13C NMR, ranging from 93.2 mol % to 90.5 mol %.

7. The polypropylene resin composition according to claim 1, wherein component A) has the intrinsic viscosity (IV), measured in tetrahydronaphthalene at 135° C., ranging from 8.5 dl/g to 5.5 dl/g.

8. The polypropylene resin composition according to claim 1, wherein component B) is selected from the group consisting of liquid paraffin, solid paraffin, wax, and mineral oil.

9. The polypropylene resin composition according to claim 1, wherein component B) is mineral oil.

10. The polypropylene resin composition according to claim 1, wherein component A) has the melt strength, measured according to ISO 16790-2005 at 250° C. and applying an acceleration equal to 6 mm/s², higher than 0.070 N.

11. The polypropylene resin composition according to claim 1, wherein component T2) has the intrinsic viscosity (IV), measured in tetrahydronaphthalene at 135° C., ranging from 2.2 to 5.0 dl/g.

12. The polypropylene resin composition according to claim 1, wherein component A) shows a polydispersity index, PI, measured according to ISO 6721-10, between 4.5 and 7.5.

13. A process for obtaining a microporous membrane, comprising the polypropylene resin composition according to claim 1, comprising the steps of:
(i) mixing organic material component B) with component A), thereby forming a mixture;
(ii) heating and melting the mixture, thereby forming a melt;
(iii) extruding the melt into a sheet,
(iv) orientating the sheet biaxially, either simultaneously or sequentially; and
(v) extracting the liquid with a volatile solvent.

14. The process according to claim 13, wherein the volatile solvent is dichloromethane.

15. A microporous membrane comprising the polypropylene resin composition according to claim 1.
